(19) United States
(12) Patent Application Publication
(10) Pub. No.: US 2014/0307809 A1
(43) Pub. Date: Oct. 16, 2014

(54) TRANSMISSION LINE

(71) Applicant: Lintes Technology Co., Ltd, New Taipei (TW)

(72) Inventor: Wei Zen Lo, New Taipei (TW)

(21) Appl. No.: 13/930,972

(22) Filed: Jun. 28, 2013

(30) Foreign Application Priority Data
Apr. 12, 2013 (CN) 201320187804.8

(51) Int. Cl. H04B 3/28; H04B 3/50; H01R 13/66

(52) U.S. Cl. CPC H04B 3/28; H01R 13/6691; H04B 3/50
USPC 375/257; 439/620.22

(57) ABSTRACT

A transmission line matable to a differential signal source, includes a first connector having a impedor and a first differential terminal pair, a second connector having a conversion module and a second differential terminal pair, and a wire electrically connected to the first and the second connectors. A differential signal received by the first differential terminal pair of the first connector at one end of the transmission line is processed by the impedor and then is converted into a single-ended signal transmitted on the wire. Then the conversion module restores the single-ended signal to the differential signal, and the differential signal is output from the second differential terminal pair of the second connector at the other end of the transmission line.

### CROSS-REFERENCE TO RELATED APPLICATIONS

This non-provisional application claims priority under 35 U.S.C. §119(a) on Patent Application No. 201320187804.8 filed in P.R. China on Apr. 12, 2013, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to a transmission line, and more particularly to a transmission line capable of implementing high speed transmission and having a low cost.

### BACKGROUND OF THE INVENTION

Currently, the amount of data transmitted between electronic devices increases sharply, and applications, such as high definition video, need to transmit data in a very high speed.

An existing transmission line can implement high speed data transmission. The transmission line has two connectors. Each connector has terminals fixed to one end of the connector and a circuit board. A control chip is disposed on each circuit board. The terminals are conductively connected to two side faces of one end of the circuit board. Differential terminal pairs are disposed in the terminals. The other ends of the two connectors are electrically connected through a cable. Twisted-pair lines for transmitting high-frequency signals are disposed in the cable to conductively connect the circuit boards of the two connectors. The twisted-pair lines are all used for transmitting high-frequency differential signals. Each differential terminal pair of one connector receives a differential signal which passes through the control chip of the connector, and the differential signal is transmitted to the control chip of the other connector through a twisted-pair line and is finally output from a differential terminal pair of the other connector.

In the forgoing structure, high-frequency signals transmitted in each twisted-pair line have the same amplitude and the reversed phases, so it is strictly required that two lines of each twisted-pair line have the equal length. The difference between the lengths of the two lines of each twisted-pair line must be less than 0.0025. That is, for a transmission line with the length of 2000 millimeter (mm), if the difference between the lengths of the two lines of each twisted-pair line is 5 mm, the transmission line is unusable. Therefore, the requirement for producing the transmission module is strict and the cost of the producing is high. Moreover, each differential signal needs to be transmitted through a twisted-pair line formed of two lines, so the width of the whole cable is large and the flexibility of the cable is not good, which is not convenient for bending molding and taking up of the cable.

Therefore, a heretofore unaddressed need exists in the art to address the aforementioned deficiencies and inadequacies.

### SUMMARY OF THE INVENTION

In one aspect, the present invention is directed to a transmission line.

In one embodiment, a transmission line matable to a differential signal source includes a first connector, a second connector and a wire. The first connector has an impedor and a first differential terminal pair fixed to the first connector. The second connector has a conversion module and a second differential terminal pair fixed to the second connector. The wire has two ends electrically connected to the first connector and the second connector respectively. When the first differential terminal pair receives a differential signal and is conductively connected to two circuits having equal impedance, a terminal of one of the circuits is connected to the impedor and a terminal of the other of the circuits is electrically connected to the wire to transmit a single-ended signal to the conversion module. The conversion module restores the single-ended signal to the differential signal and outputs the differential signal to the second differential terminal pair, and one differential terminal of the first differential terminal pair and the electronic circuit for transmitting the single-ended signal have equal high-frequency impedance.

Further, the impedor is a terminal resistor and is grounded, and can consume energy on one of the two circuits to convert the transmission into single-ended transmission on one circuit. The impedor is grounded to avoid interference with signals of corresponding ends.

Further, the electronic circuit for transmitting the single-ended signal is only the wire.

Further, the first differential terminal pair and the wire are conductively connected to a first circuit board. The electronic circuit for transmitting the single-ended signal includes circuits on the first circuit board and the wire. One differential terminal of the first differential terminal pair, the circuits on the first circuit board and the wire have equal high-frequency impedance, so that the signal loss during transmission is small.

Further, the conversion module has an identification element, and the single-ended signal is restored to the differential signal after being identified by the identification element and processed by the conversion module.

Further, the wire is a coaxial wire, so that interference can be avoided when a high-frequency signal is transmitted in the wire.

Further, the first connector has a first circuit board, the second connector has a second circuit board, and shielding layers at two ends of the wire are conductively connected to a shielding pad of the first circuit board and a shielding pad of the second circuit board respectively, thereby avoiding interference with signals in the wire.

Further, the conversion module has an amplification element, and the differential signal received by the first differential terminal pair is amplified by the amplification element and then is conductively connected to the two circuits.

Further, when one first differential terminal pair and one second differential terminal pair are added, one wire is added correspondingly. The first connector further has the conversion module. The second connector further has the impedor. A differential signal received by the added second differential terminal pair is transmitted from the second connector to the first connector and the added first differential terminal pair outputs the differential signal, which is the same as a transmission mode for transmitting a signal from the first connector to the second connector.

In another embodiment, a transmission line matable to a differential signal source includes a first connector, a second connector, and a first wire and a second wire. The first connector has a first impedor and a first conversion module, and two first differential terminal pairs are fixed to the first connector. The second connector has a second impedor and a second conversion module, and two second differential terminal pairs are fixed to the second connector. Each of the first wire and the second wire has two ends electrically connected to the first connector and the second connector respectively. In a first direction, one of the first differential terminal pairs receives a differential signal and is conductively connected to two first circuits having equal impedance. A terminal of one of the first circuits is connected to the first impedor. A terminal of the other of the first circuits is electrically connected to the first wire to transmit a single-ended signal to the second conversion module. One differential terminal of the first differential terminal pair and a first electronic circuit for transmitting the single-ended signal have equal high-frequency impedance. The second conversion module restores the single-ended signal to the differential signal and outputs the differential signal to one of the second differential terminal pairs. Meanwhile, in a second direction, the other of the second differential terminal pairs receives a differential signal and is conductively connected to two second circuits having equal impedance. A terminal of one of the second circuits is connected to the second impedor. A terminal of the other of the second circuits is electrically connected to the second wire to transmit a single-ended signal to the first conversion module. The first conversion module restores the single-ended signal to the differential signal and outputs the differential signal to the other of the first differential terminal pairs. One differential terminal of the second differential terminal pair and a second electronic circuit for transmitting the single-ended signal have equal high-frequency impedance.

Further, the first impedor and the second impedor both are terminal resistors and are grounded, and can consume energy on one of the two first circuits and one of the two second circuits to convert the transmission into single-ended transmission on one circuit. The impedor is grounded to avoid interference with signals of corresponding ends.

Further, the first electronic circuit is only the first wire and the second electronic circuit is only the second wire.

Further, the first differential terminal pair and the first wire are conductively connected to a first circuit board. The second differential terminal pair and the second wire are conductively connected to a second circuit board. The first electronic circuit includes circuits on the first circuit board and the first wire. One differential terminal of the first differential terminal pair, the circuits on the first circuit board and the first wire have equal high-frequency impedance. The second electronic circuit includes circuits on the second circuit board and the second wire. One differential terminal of the second differential terminal pair, the circuits on the second circuit board and the second wire have equal high-frequency impedance. Accordingly, the signal loss is small when being transmitted on the first electronic circuit and the second electronic circuit.

Further, the first conversion module and the second conversion module each have an identification element, and single-ended signals in two directions are restored to differential signals after being identified by corresponding identification elements and processed by the first conversion module and the second conversion module.

Further, the first wire and the second wire are both coaxial wires, so that interference can be avoided when high-frequency signals are transmitted in the first wire and the second wire.

Further, the transmission line includes a cable. The cable includes the first wire and the second wire. An outer rubber sheath, an inner rubber sheath, and a weave layer located between the outer rubber sheath and the inner rubber sheath and used for shielding are disposed outside the cable.

Further, the cable has the two first wires, the two second wires, two power supply lines, two ground lines, and two low-frequency lines. Four first differential terminal pairs and four second differential terminal pairs are disposed correspondingly.

Further, the two first wires, the two second wires, and the two power supply lines are distributed along an inner surface of the inner rubber sheath. The two ground lines and the two low-frequency lines are distributed in a space defined by the inner surface of the inner rubber sheath. Other portion of the space defined by the inner surfaces of the inner rubber sheath is filled with nylon threads, fiber threads, or both, so that the whole cable is compact.

Further, the first connector has a first circuit board, and the second connector has a second circuit board. The two first wires and the two second wires are conductively connected to the first circuit board at the same surface of the first circuit board and are conductively connected to the second circuit board at the same surface of the second circuit board.

Further, two ends of the cable are each disposed with a retaining rack. The retaining rack fix the two first wires, the two second wires, the two power supply lines, the two ground lines, and the two low-frequency lines and enables them to correspond to soldering pads on the first circuit board and the second circuit board for soldering.

Further, the first conversion module and the second conversion module each have an amplification element. Differential signals received by the first differential terminal pair and the second differential terminal pair are amplified by the amplification elements.

Compared with related art, the present invention provides a transmission line, where a differential signal received by a differential terminal pair of a connector at one end of the transmission line is processed by an impedor and then is converted into a single-ended signal transmitted on a corresponding wire, then a corresponding conversion module restores the single-ended signal to the differential signal, and the differential signal is output from a differential terminal pair of a connector at the other end of the transmission line. In the transmission line, two wires having the equal length are not required to implement differential transmission. In the related art, a differential signal must be transmitted through two wires, while in the present invention, only one wire is required for transmission. Therefore, the total width of the wire can be greatly reduced, so that the whole wire is soft and it is easy for a user to bend and rewind the wire according to use requirements, and meanwhile, the wire material cost of the manufacture can be reduced.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a schematic three-dimensional view of a transmission line according to one embodiment of the present invention;

FIG. 2 is a schematic partial sectional view of a transmission line according to a first embodiment of the present invention;

FIG. 3 is a schematic three-dimensional view and a schematic partial enlarged view of FIG. 2;

FIG. 4 is a schematic view of terminal distribution of a first connector and a second connector in FIG. 2;

FIG. 5 is a schematic sectional view of a cable in FIG. 2;

FIG. 6 is a schematic three-dimensional view and a schematic partial enlarged view of a transmission line according to a second embodiment of the present invention;

FIG. 7 is a schematic partial cutaway view of FIG. 6;

FIG. 8 is a schematic exploded view of a first connector in FIG. 6; and

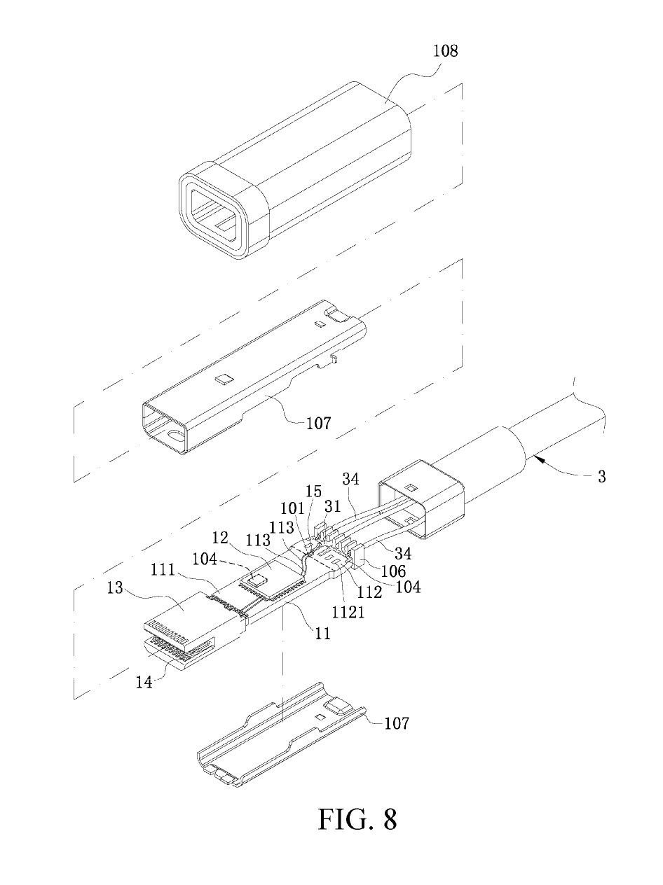

FIG. 9 is a schematic three-dimensional view and a partial enlarged view of a first circuit board in FIG. 8 and connection elements on the first circuit board.

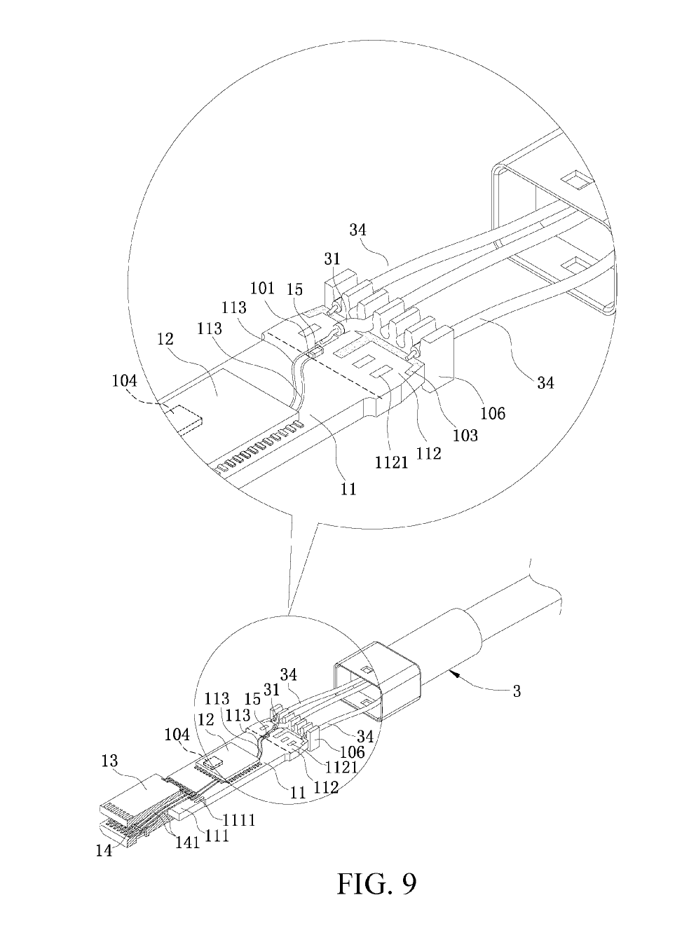

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of example embodiments.

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

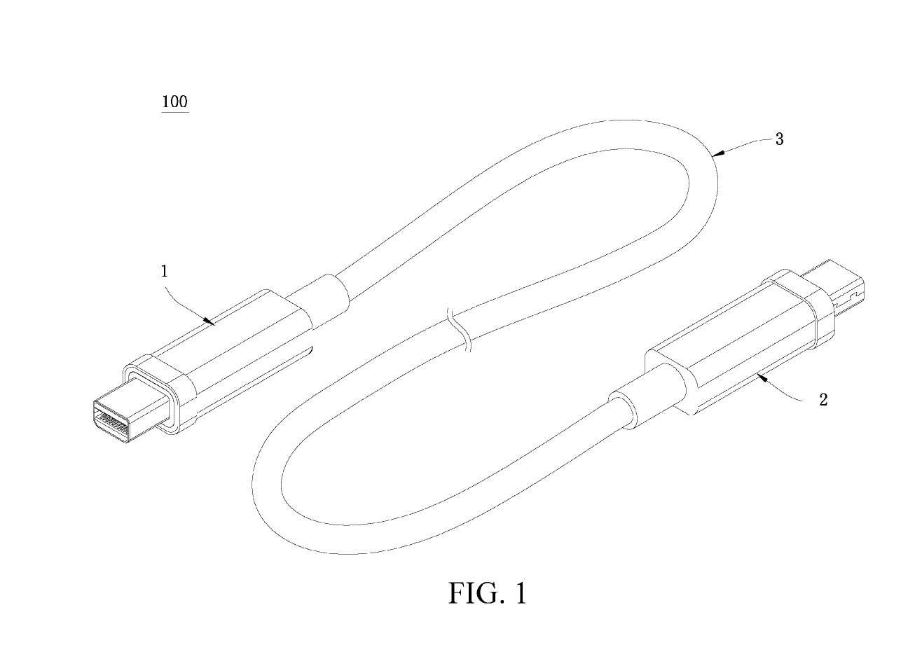

Referring to FIG. 1, in certain embodiment of the present invention, a transmission line 100 is used for transmitting data between a first electronic apparatus (not shown) and a second electronic apparatus (not shown). The first electronic apparatus and the second electronic apparatus are both differential signal sources and can provide differential signals. The transmission line 100 includes a cable 3, and a first connector 1 and a second connector 2 connected to two ends of the cable 3 respectively.

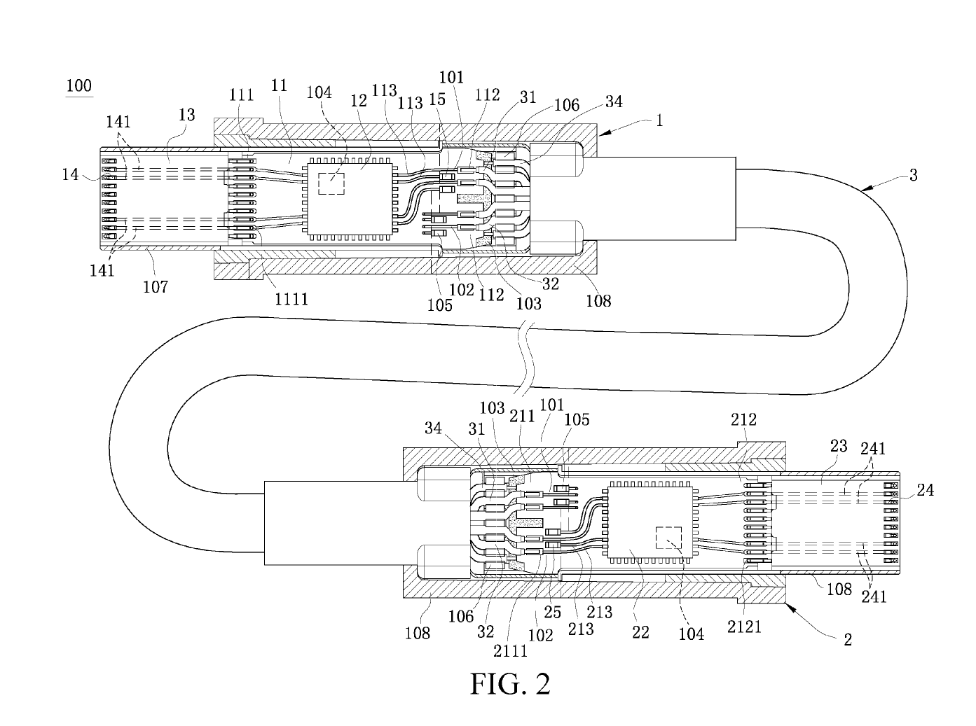

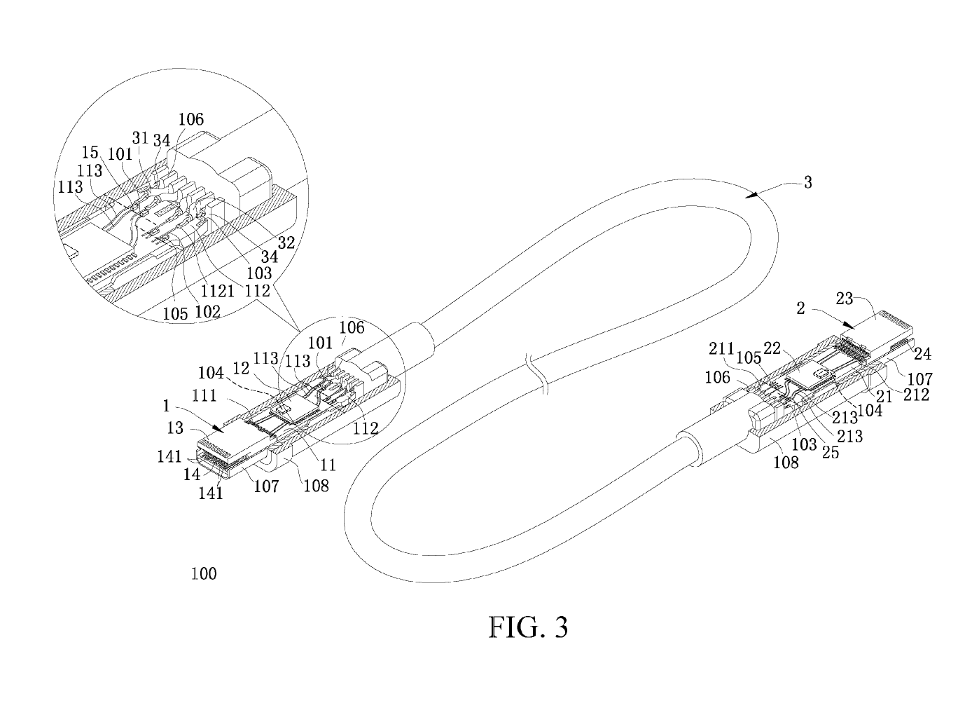

Referring to FIGS. 2 and 3, the first connector 1 has a first circuit board 11, and at least one first conversion module 12 is disposed on the first circuit board 11. In this embodiment, only one first conversion module 12 is disposed on the first circuit board 11. The first circuit board 11 has a first conductive connection portion 111 and a second conductive connection portion 112. The first conductive connection portion 111 is located at one end of the first circuit board 11 and the second conductive connection portion 112 is located at the other end of the first circuit board 11. The first conductive connection portion 111 has a plurality of first pads 1111 located on two opposite side faces of the first circuit board 11. The number of first pads 1111 distributed on the upper side of the first conductive connection portion 111 is the same as the number of first pads 1111 distributed on the lower side of the first conductive connection portion 111, and the location of the upper first pads and the location of the lower first pads are aligned correspondingly. The second conductive connection portion 112 has a plurality of second pads 1121 located on the same side face of the first circuit board 11.

Referring again to FIGS. 2 and 3, the first connector 1 has a first insulation body 13 and a plurality of first terminals 14. The first terminals 14 are accommodated in the first insulation body 13 in two rows, and soldering portions (not shown) of the plurality of first terminals 14 are soldered to the first conductive connection portion 111 and are conductively connected to the plurality of first pads 1111. The plurality of first terminals 14 has four first differential terminal pairs 141. Two of the first differential terminal pairs 141 are differential signal input terminals and the other two of the first differential terminal pairs 141 are differential signal output terminals. Each first differential terminal pair 141 being a differential signal input is electrically connected to the first conversion module 12 and conductively connected to two first circuits 113. The two first circuits 113 have equal impedance and are disposed on the first circuit board 11. A terminal of one of the first circuits 113 is connected to a first impedor 15. The first impedor 15 is a terminal resistor and is grounded.

Referring to FIGS. 2 and 3, the structure of the second connector 2 is similar to that of the first connector 1. The second connector 2 has a second circuit board 21. At least one second conversion module 22 is disposed on the second circuit board 21. Similarly, in this embodiment, only one second conversion module 22 is disposed on the second circuit board 21. The second circuit board 21 has a third conductive connection portion 211 and a fourth conductive connection portion 212. The third conductive connection portion 211 is located at one end of the second circuit board 21, and the fourth conductive connection portion 212 is located at the other end of the second circuit board 21. The fourth conductive connection portion 212 has a plurality of fourth pads 2121 located on two opposite side faces of the second circuit board 21. The number of fourth pads 2121 distributed on the upper side of the fourth conductive connection portion 212 is the same as the number of fourth pads 2121 distributed on the lower side of the fourth conductive connection portion 212, and the location of the upper fourth pads and the location of the lower fourth pads are aligned correspondingly. The third conductive connection portion 211 has a plurality of third pads 2111 located on the same side face of the second circuit board 21.

Referring to FIGS. 2 and 3, the second connector 2 has a second insulation body 23 and a plurality of second terminals 24. The second terminals 24 are accommodated in the second insulation body 23 in two rows. Soldering portions (not shown) of the plurality of second terminals 24 are soldered to the fourth conductive connection portion 212 and are conductively connected to the plurality of fourth pads 2121. Similarly, the plurality of second terminals 24 has four second differential terminal pairs 241. Two of the second differential terminal pairs 241 are differential signal input terminals and the other two of the second differential terminal pairs 241 are differential signal output terminals. Each second differential terminal pair 241 being a differential signal input is electrically connected to the second conversion module 22 and conductively connected to two second circuits 213. The two second circuits 213 have equal impedance. A terminal of one of the second circuits 213 is connected to a second impedor 25. The second impedor 25 is a terminal resistor and is grounded.

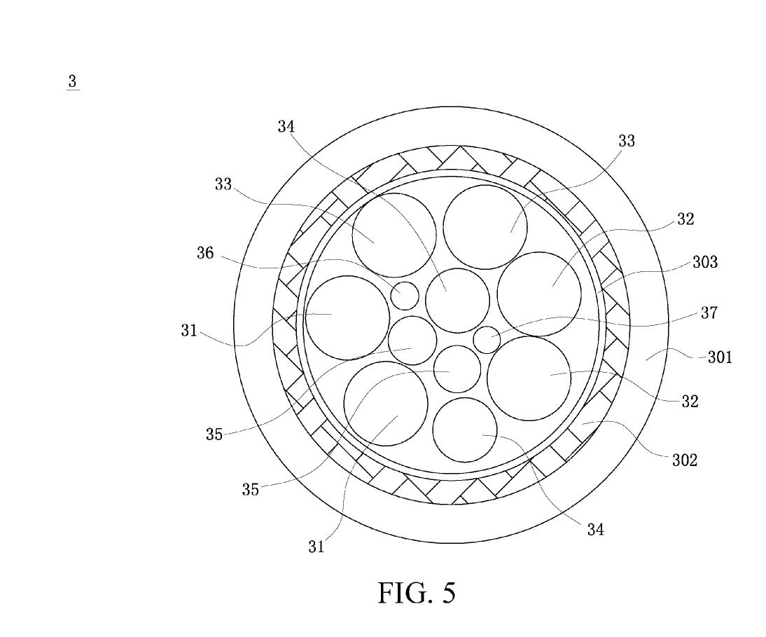

Referring to FIGS. 3 and 5, the cable 3 has two first wires 31 and two second wires 32. The first wire 31 and the second wire 32 are both coaxial wires. Two ends of the first wire 31 are conductively connected to the second pad 1121 and the third pad 2111 respectively, and two ends of the second wire 32 are conductively connected to the second pad 1121 and the third pad 2111 respectively. Each first wire 31 and each second wire 32 correspond to the first differential terminal pair 141 and the second differential terminal pair 241, respectively. A side of the plurality of second pads 1121 and a side of the plurality of fourth pads 2121 are each disposed with a shielding pad 103. Shielding layers (not shown) at two ends of the first wire 31 and two ends of the second wire 32 are conductively connected to the shielding pads 103.

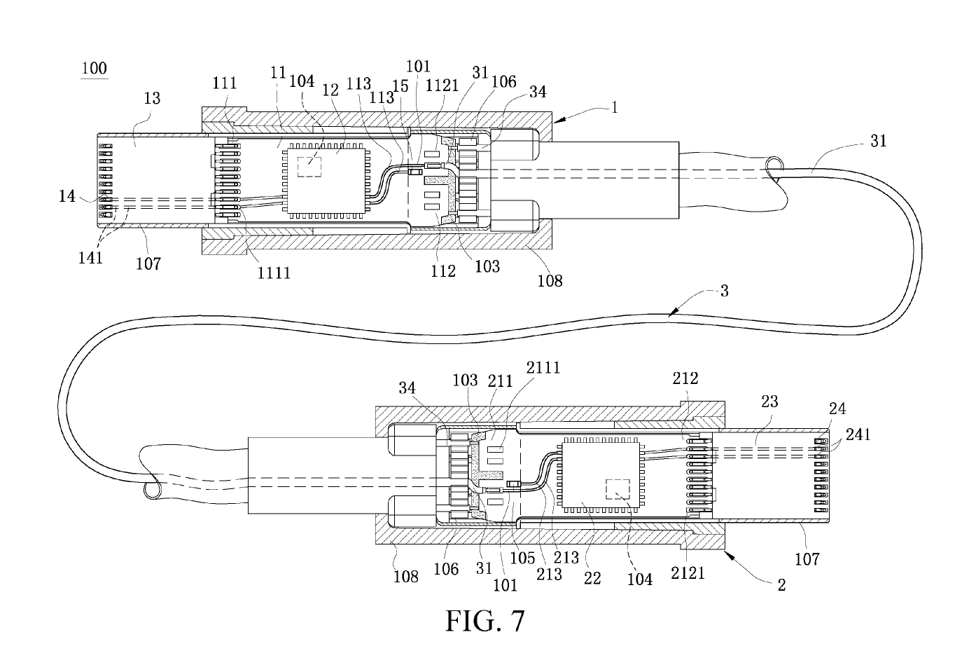

Referring to FIGS. 2 and 3, in a first direction, each first differential terminal pair 141 being a differential signal input receives a differential signal from the first electronic apparatus (not shown) and transmits the differential signal to the first conversion module 12. The two first circuits 113 having equal impedance are conductively connected to the first conversion module 12. The terminal of one of the first circuits 113 is connected to the first impedor 15, for consuming energy on the first circuit 113 connected to the first impedor 15. A terminal of the other of the first circuits 113 is electrically connected to the first wire 31, to transmit a single-ended signal to the second conversion module 22. One differential terminal of each first differential terminal pair 141 and a first electronic circuit 101 for transmitting the single-ended signal have equal high-frequency impedance. The second conversion module 22 restores the single-ended signal to the differential signal and outputs the differential signal to the second differential terminal pair 241 being a differential signal output. Here, the first electronic circuit 101 is used for transmitting the single-ended signal and includes the circuits on the first circuit board 11, the first wire 31, and the circuits on the second circuit board 21 (that is, circuits from a dotted line on the first circuit board 11 to a dotted line on the second circuit board 21 in FIG. 2 or 7). One differential terminal of the first differential terminal pair 141, the circuits on the first circuit board 11, the first wire 31, and the circuits on the second circuit board 21 have equal high-frequency impedance, so that signals can be transmitted on the first electronic circuit 101 smoothly and the signal loss is small during transmission.

Meanwhile, in a second direction opposite to the first direction, each second differential terminal pair 241 being a differential signal input receives a differential signal from the second electronic apparatus (not shown) and transmits the differential signal to the second conversion module 22. The two second circuits 213 having equal impedance are conductively connected to the second conversion module 22. The terminal of one of the second circuits 213 is connected to the second impedor 25, for consuming energy on the second circuit 213 connected to the second impedor 25. A terminal of the other of the second circuits 213 is electrically connected to the second wire 32, to transmit a single-ended signal to the first conversion module 12. The first conversion module 12 restores the single-ended signal to the differential signal and outputs the differential signal to the first differential terminal pair 141 being a differential signal output. Similarly, one differential terminal of each second differential terminal pair 241 and a second electronic circuit 102 for transmitting the single-ended signal have equal high-frequency impedance. Similarly, the second electronic circuit 102 is used for transmitting the single-ended signal and includes the circuits on the first circuit board 11, the second wire 32, and the circuits on the second circuit board 21 (that is, circuits from a dotted line on the second circuit board 21 to a dotted line on the first circuit board 11 in FIG. 2 or 7). One differential terminal of the second differential terminal pair 241, the circuits on the second circuit board 21, the second wire 32, and the circuits on the first circuit board 11 have equal high-frequency impedance, so that signals can be transmitted on the second electronic circuit 102 smoothly and the signal loss is small during transmission.

In other embodiments, the first electronic circuit 101 and the second electronic circuit 102 may be only the first wire 31 and the second wire 32 respectively.

Referring to FIGS. 2 and 3, the principle for restoring the single-ended signal to the differential signal in the first direction is the same as that in the second direction. The first direction is taken as an example. On the first circuit board 11 and the second circuit board 21, the first conversion module 12 and the second conversion module 22 each have an amplification element 104 and an identification element 105. When a single-ended signal is transmitted onto the second circuit board 21, the identification element 105 identifies the single-ended signal. The identification element 105 gives a zero potential and is electrically connected to the second conversion module 22. The zero potential and the single-ended signal are input into the second conversion module 22 as two inputs. The single-ended signal is converted into a differential signal after being amplified by the amplification element 104 and restored by the second conversion module 22. The differential signal is allocated to the second differential terminal pair 241 being a differential signal output. A differential signal received by the first terminal pair 141 from the first electronic apparatus (not shown) is amplified by the amplification element 104 of the first conversion module 12, and similarly, a differential signal received by the second terminal pair 241 from the second electronic apparatus (not shown) is amplified by the amplification element 104 of the second conversion module 22, so that the length of the cable 3 can be appropriately increased.

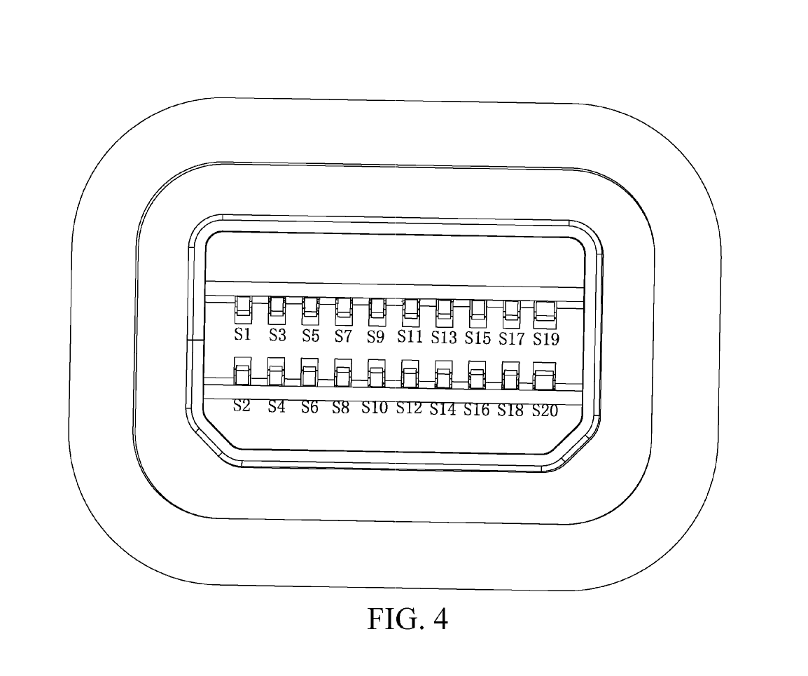

Referring to FIGS. 2 and 4, the model of the first connector 1 is the same as that of the second connector 2. The two connectors can be randomly switched to be electrically connected to the first electronic apparatus (not shown) and the second electronic apparatus (not shown). The first connector 1 and the second connector 2 each have twenty terminals S1 to S20. Terminals in the upper row are numbered with odd numbers, and terminals in the lower row are number with even numbers. The terminals in the upper row are aligned with the terminals in the lower row. The numbers in each row are increased from one side to the other side. The twenty terminals S1 to S20 include two power supply terminals (S1, S20), two low-frequency signal terminals (S9, S11), two differential signal input terminal pairs (S3 and S5, S15 and S17), and two differential signal output terminal pairs (S4 and S6, S16 and S18). One power supply terminal (S20) is used for power supply input, and the other power supply terminal (S1) is used for power supply output. Alternatively, in other embodiments, the number of terminals and the number of functional terminals can be set differently according to requirements.

Referring to FIGS. 2, 4, and 5, in this embodiment, the cable 3 further includes two power supply lines 33 electrically connected to the two power supply terminals (S1, S20) respectively, two ground lines 34, and two low-frequency lines 35 electrically connected to the two low-frequency signal terminals (S9, S11). Two ends of each ground line 34 are conductively connected to the shielding pads 103 on the first circuit board 11 and the second circuit board 21 respectively, and the number of ground lines 34 can be set differently according to requirements. The cable 3 has an outer rubber sheath 301, an inner rubber sheath 303, and a weave layer 302 located between the outer rubber sheath 301 and the inner rubber sheath 303 and used for shielding. The two first wires 31, the two second wires 32, and the two power supply lines 33 are distributed along the surface of an inner surface of the inner rubber sheath 303. The two ground lines 34 and the two low-frequency lines 35 are distributed in a space defined by the inner surface of the inner surface of the inner rubber sheath 303. Other portion of the space defined by the inner surface of the inner rubber sheath 303 is filled with nylon threads 36 and fiber threads 37. Further, two ends of the cable 3 are each disposed with a retaining rack 106. A plurality of retaining slots (not shown) is disposed at the upper and lower sides of each retaining rack 106. The two first wires 31, the two second wires 32, the two power supply lines 33, the two ground lines 34, and the two low-frequency lines 35 are fixed in the plurality of retaining slots (not shown) according to predetermined soldering positions, so that it is convenient to solder the cable 3 onto the first circuit board 11 and the second circuit board 21. In other embodiments, a space filling material of the inner rubber sheath 303 can be one of the nylon thread 36 and the fiber thread 37. Alternatively, the other spaces may also be filled with lines of other materials.

Referring to FIGS. 2 and 3, each of the first connector 1 and the second connector 2 has a metal casing body 107 and a plastic shell 108 covering the metal casing body 107. The metal casing body 107 covers the first circuit board 11 and the first insulation body 13. The metal casing body 107 covers the second circuit board 21 and the second insulation body 23. The weave layer 302 at the two ends of the cable 3 is conductively connected to the metal casing bodies 107, so that the differential signal and the single-ended signal in the whole transmission line 100 are transmitted in a shielded environment.

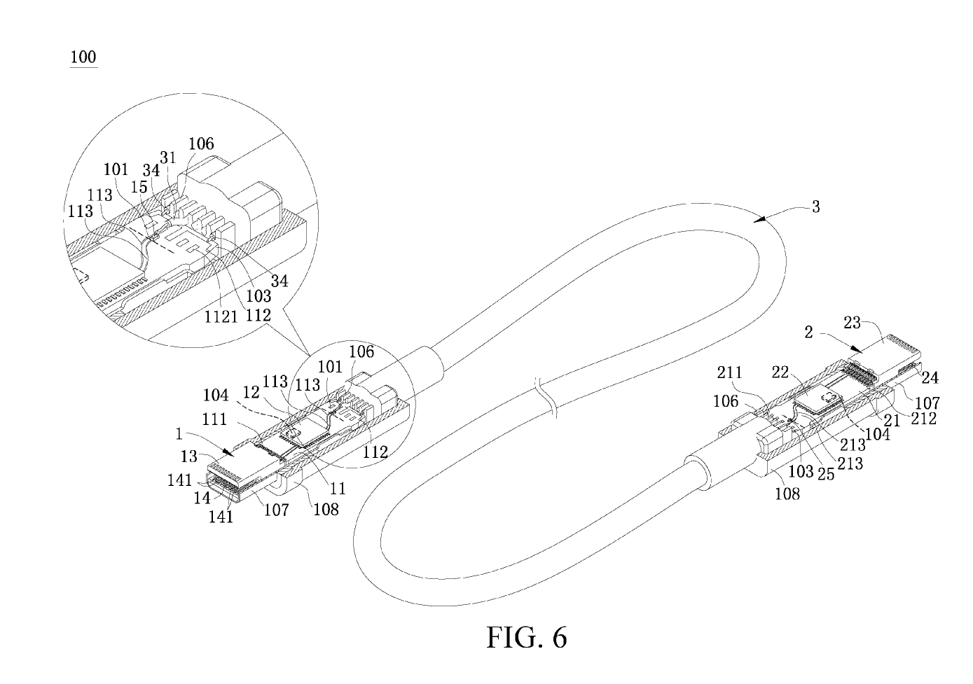

Referring to FIGS. 6 and 7, a second embodiment of the present invention is shown. The structures of the first connector 1 and the second connector 2 may be different. The difference from the first embodiment is that, a differential signal is only transmitted from one of the first connector 1 and the second connector 2 to the other. For example, the differential signal is only transmitted in the first direction. The first connector 1 has one first impedor 15 and one first differential terminal pair 141. The second connector 2 has one second conversion module 22 and one second differential terminal pair 241. The first differential terminal pair 141 receives a differential signal output from the first electronic apparatus (not shown), and is conductively connected to the two first circuits 113 having equal impedance on the first circuit board 11. Similarly, a terminal of one of the first circuits 113 is connected to the first impedor 15, and a terminal of the other of the first circuits 113 is electrically connected to the first wire 31, to transmit a single-ended signal to the second conversion module 22. The second conversion module 22 restores the single-ended signal to the differential signal and outputs the differential signal to the second differential terminal pair 241. One differential terminal of the first differential terminal pair 241 and the first electronic circuit 101 for transmitting the single-ended signal have equal high-frequency impedance. Similarly, the first impedor 15 is grounded.

The difference between a third embodiment of the present invention and the second embodiment is that, one first differential terminal pair 141 and one second differential terminal pair 241 are added, and one second wire 32 is added correspondingly. The first connector 1 further has the first conversion module 12, the second connector 2 further has the second impedor 25, and a differential signal received by the added second differential terminal pair 241 in the second direction is transmitted to the first connector 1 from the second connector 2 and the added first differential terminal pair 141 outputs the differential signal, which is the same as a transmission mode for transmitting the differential signal from the first connector 1 to the second connector 2 in the first direction.

In sum, the transmission line 100 according to certain embodiment of the present invention, among other things, has the following beneficial advantages.

1. Differential signals received at the two ends of the transmission line 100 are correspondingly converted into signals transmitted on the first wire 31 and the second wire 32 in a single-ended manner, and are correspondingly restored to the differential signals by the first conversion module 12 and the second conversion module 22. In the transmission process of the transmission line, two wires having equal length are not required to implement differential transmission. In the related art, a differential signal must be transmitted through two wires. While in the present invention, only one wire is required for transmission. Therefore, the total width of the cable 3 can be greatly reduced, so that the whole cable is soft and it is easy for a user to bend and rewind the cable according to use requirements. Meanwhile, the material cost of the cable 3 of the manufacture can be reduced.

2. The first wire 31 and the second wire 32 are coaxial wires, so that interference can be avoided when high-frequency signals are transmitted in the cable 3.

3. The first impedor 15 and the second impedor 25 are disposed to consume energy on one of the first circuit 113 and the second circuit 213, so that the transmission is converted into single-ended transmission on one circuit. The first impedor 15 and the second impedor 25 are both grounded, thereby avoiding interference with signals of corresponding ends. The first impedor 15 and the second impedor 25 are both terminal resistors, so that the transmission line 100 has a simple structure and a low cost.

4. The two first wires 31, the two second wires 32, and the two power supply lines 33 are distributed along the inner surface of the inner rubber sheath 303, the two ground lines 34 and the two low-frequency lines 35 are distributed in the space defined by the inner surface of the inner rubber sheath 303, and other portion of the space defined by the inner surface of the inner rubber sheath 303 are filled with nylon threads 36 and fiber threads 37, so the whole cable 3 is compact.

5. One differential terminal of the first differential terminal pair 141, the circuits on the first circuit board 11, the first wire 31, and the circuits on the second circuit board 21 have equal high-frequency impedance, and one differential terminal of the second differential terminal pair 241, the circuits on the second circuit board 21, the second wire 32, and the circuits on the first circuit board 11 have equal (that is, matching) high-frequency impedance, so that signals can be transmitted on the first electronic circuit 101 and the second electronic circuit 102 smoothly and the signal loss is small during transmission.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A transmission line matable to a differential signal source, comprising:
a first connector, having a first impedor and a first differential terminal pair fixed to the first connector;
a second connector, having a first conversion module and a second differential terminal pair fixed to the second connector; and
a first wire, having two ends electrically connected to the first connector and the second connector respectively,
wherein when the first differential terminal pair receives a differential signal and is conductively connected to two circuits having equal impedance, a terminal of one of the circuits is connected to the first impedor and a terminal of the other of the circuits is electrically to the first wire to transmit a single-ended signal to the first conversion module, the first conversion module restores the single-ended signal to the differential signal and outputs the differential signal to the second differential terminal pair, and one differential terminal of the first differential terminal pair and an electronic circuit for transmitting the single-ended signal have equal high-frequency impedance.

2. The transmission line according to claim 1, wherein the first impedor is a terminal resistor and is grounded.

3. The transmission line according to claim 1, wherein the electronic circuit for transmitting the single-ended signal is only the first wire.

4. The transmission line according to claim 1, wherein the first differential terminal pair and the first wire are conductively connected to a first circuit board, the electronic circuit for transmitting the single-ended signal comprises circuits on the first circuit board and the first wire, and one differential terminal of the first differential terminal pair, the circuits on the first circuit board and the first wire have equal high-frequency impedance.

5. The transmission line according to claim 1, wherein the first conversion module has an identification element, and the single-ended signal is restored to the differential signal after being identified by the identification element and processed by the first conversion module.

6. The transmission line according to claim 1, wherein the first wire is a coaxial wire.

7. The transmission line according to claim 6, wherein the first connector has a first circuit board, the second connector has a second circuit board, and shielding layers at two ends of the first wire are conductively connected to a shielding pad of the first circuit board and a shielding pad of the second circuit board respectively.

8. The transmission line according to claim 1, wherein the first conversion module has an amplification element, and the differential signal received by the first differential terminal pair is amplified by the amplification element and then is conductively connected to the two circuits.

9. The transmission line according to claim 1,
wherein the first connector further comprises a third differential terminal pair and a second conversion module;
wherein the second connector further comprises a fourth differential terminal pair and a second impedor;
wherein the transmission line further comprises a second wire; and
wherein a differential signal received by the fourth differential terminal pair is transmitted from the second connector to the first connector and the third differential terminal pair outputs the differential signal, a transmission mode from the second connector to the first connector is the same as a transmission mode from the first connector to the second connector.

10. A transmission line matable to a differential signal source, comprising:
a first connector, having a first impedor and a first conversion module, wherein two first differential terminal pairs are fixed to the first connector;
a second connector, having a second impedor and a second conversion module, wherein two second differential terminal pairs are fixed to the second connector; and
a first wire and a second wire, each having two ends electrically connected to the first connector and the second connector respectively,
wherein in a first direction, one of the first differential terminal pairs receives a differential signal and is conductively connected to two first circuits having equal impedance, a terminal of one of the first circuits is connected to the first impedor, a terminal of the other of the first circuits is electrically connected to the first wire to transmit a single-ended signal to the second conversion module, one differential terminal of the first differential terminal pair and a first electronic circuit for transmitting the single-ended signal have equal high-frequency impedance, and the second conversion module restores the single-ended signal to the differential signal and outputs the differential signal to one of the second differential terminal pairs; and
wherein in a second direction, the other of the second differential terminal pairs receives a differential signal and is conductively connected to two second circuits having equal impedance, a terminal of one of the second circuits is connected to the second impedor, a terminal of the other of the second circuits is electrically connected to the second wire to transmit a single-ended signal to the first conversion module, the first conversion module restores the single-ended signal to the differential signal and outputs the differential signal to the other of the first differential terminal pairs, and one differential terminal of the second differential terminal pair and a second electronic circuit for transmitting the single-ended signal have equal high-frequency impedance.

11. The transmission line according to claim 10, wherein the first impedor and the second impedor are both terminal resistors and are grounded.

12. The transmission line according to claim 10, wherein the first electronic circuit is only the first wire and the second electronic circuit is only the second wire.

13. The transmission line according to claim 10, wherein the first differential terminal pair and the first wire are conductively connected to a first circuit board, the second differential terminal pair and the second wire are conductively connected to a second circuit board, the first electronic circuit comprises circuits on the first circuit board and the first wire, the first differential terminal, the circuits on the first circuit board and the first wire have equal high-frequency impedance, the second electronic circuit comprises circuits on the second circuit board and the second wire, and one differential terminal of the second differential terminal pair, the circuits on the second circuit board and the second wire have equal high-frequency impedance.

14. The transmission line according to claim 10, wherein the first conversion module and the second conversion module each have an identification element, and single-ended signals in two directions are restored to differential signals after being identified by corresponding identification elements and processed by the first conversion module and the second conversion module.

15. The transmission line according to claim 10, wherein the first wire and the second wire are both coaxial wires.

16. The transmission line according to claim 10, further comprising a cable, wherein the cable comprises the first wire and the second wire, and an outer rubber sheath, an inner rubber sheath, and a weave layer located between the outer rubber sheath and the inner rubber sheath and used for shielding are disposed outside the cable.

17. The transmission line according to claim 16, wherein the cable has the two first wires, the two second wires, two power supply lines, two ground lines, and two low-frequency lines, and four first differential terminal pairs and four second differential terminal pairs are disposed correspondingly.

18. The transmission line according to claim 17, wherein the two first wires, the two second wires, and the two power supply lines are distributed along an inner surface of the inner rubber sheath, the two ground lines, the two low-frequency lines and at least one of nylon threads and fiber threads are distributed in a space defined by the inner surface of the inner rubber sheath.

19. The transmission line according to claim 17, wherein the first connector has a first circuit board, the second connector has a second circuit board, and the two first wires and the two second wires are conductively connected to the first circuit board at one surface of the first circuit board and are conductively connected to the second circuit board at one surface of the second circuit board.

20. The transmission line according to claim 19, wherein two ends of the cable are each disposed with a retaining rack, and the retaining rack fixes the two first wires, the two second wires, the two power supply lines, the two ground lines, and the two low-frequency lines and enables the two first wires, the two second wires, the two power supply lines, the two ground lines, and the two low-frequency lines to correspond to pads on the first circuit board and the second circuit board.

21. The transmission line according to claim 10, wherein the first conversion module and the second conversion module each have an amplification element, and differential signals received by the first differential terminal pair and the second differential terminal pair are amplified by the amplification elements.
